(19) United States
(12) Patent Application Publication
(10) Pub. No.: US 2025/0263026 A1
(43) Pub. Date: Aug. 21, 2025

(54) VEHICLE EMBLEM

(71) Applicant: TOYODA GOSEI CO., LTD., Kiyosu-shi (JP)

(72) Inventor: Hideki TOYOYAMA, Kiyosu-shi (JP)

(21) Appl. No.: 18/999,320

(22) Filed: Dec. 23, 2024

(30) Foreign Application Priority Data
Feb. 15, 2024 (JP) 2024-021178

(51) Int. Cl. B60R 13/00

(52) U.S. Cl. CPC B60R 13/005

(57) ABSTRACT

A vehicle emblem includes a base portion, a cover portion that covers the base portion, a decorative portion that decorates the cover portion, and an adhesive layer for bonding the decorative portion to the cover portion. The decorative portion includes a decorative main body bonded to the cover portion via the adhesive layer, and an extension extending outward from the decorative main body beyond the cover portion. The extension includes a through-hole extending through the extension in the facing direction. One of the base portion and the cover portion includes an attachment portion. The attachment portion includes a facing portion facing the extension, and a protruding portion inserted into the through-hole. The protruding portion includes a retaining portion that is located on a distal side of the through-hole in the facing direction. The retaining portion retains the protruding portion in the through-hole.

### CROSS-REFERENCE TO RELATED APPLICATIONS

This application is based upon and claims the benefit of priority from Japanese Patent Application No. 2024-021178, filed on Feb. 15, 2024, the entire contents of which are incorporated herein by reference.

### BACKGROUND

### 1. Field

The present disclosure relates to a vehicle emblem.

### 2. Description of Related Art

Japanese Laid-Open Patent Publication No. 2023-117622 discloses a luminous emblem attached to a vehicle. This luminous emblem includes a substrate on which light sources are installed, a housing to which the substrate is fixed, and a cover attached to the housing to cover the light sources.

An emblem member formed by plating the surface of a plastic base is placed on the surface of the cover.

The emblem member includes fixing portions extending outward beyond the cover. The fixing portions each have a hole for a screw.

The emblem member is fixed to a mounting object, to which the luminous emblem is to be attached, by tightening screws through the holes in the fixing portions.

Additionally, the above-described publication discloses an alternative method in which the emblem member is fixed to the cover with double-sided tape, instead of using the fixing portions to fix the emblem member to the mounting object.

When the emblem member of the luminous emblem is fixed to the mounting object via the fixing portions, the following problems occur. If the base of the emblem member has deformations such as warpage due to molding shrinkage, the emblem member may separate from the surface of the cover. This may diminish the aesthetic quality of the luminous emblem.

Furthermore, the mounting object must additionally have bosses into which the screws are fastened. This complicates the structure of the mounting object.

In this regard, as disclosed in the above publication, the emblem member may be fixed to the cover using double-sided tape instead of fixing portions. While this approach prevents separation of the emblem member without compromising the aesthetic quality of the luminous emblem, another issue arises: the adhesive strength of the tape may weaken due to aging, causing the emblem member to detach from the cover.

These problems are not limited to luminous emblems, and may similarly occur in any vehicle emblem that includes a decorative portion such as an emblem member.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle emblem includes a base portion, a cover portion that covers the base portion from an outside of the vehicle, a decorative portion that includes a base made of a plastic and decorates the cover portion, and an adhesive layer for bonding the decorative portion to the cover portion. The decorative portion includes a decorative main body bonded to the cover portion via the adhesive layer, and an extension extending outward from the decorative main body beyond the cover portion. A direction in which the base portion and the cover portion face each other is referred to as a facing direction. The extension includes a through-hole extending through the extension in the facing direction. One of the base portion and the cover portion includes an attachment portion to which the extension is attached. The attachment portion includes a facing portion facing the extension in the facing direction, and a protruding portion that protrudes in the facing direction from the facing portion and is inserted into the through-hole. The protruding portion includes a retaining portion that is located on a distal side of the through-hole in the facing direction, the retaining portion coming into contact with a peripheral edge of the through-hole to retain the protruding portion in the through-hole.

Other features and aspects will be apparent from the following detailed description, the drawings, and the claims.

### BRIEF DESCRIPTION OF THE DRAWINGS

FIG. 1 is a front view showing a luminous emblem that is a vehicle emblem according to an embodiment.

FIG. 2 is a cross-sectional view taken along line 2-2 in FIG. 1.

FIG. 3 is a cross-sectional view taken along line 3-3 in FIG. 1.

FIG. 4 is a cross-sectional view corresponding to FIG. 3, showing an attachment portion according to a modification.

FIG. 5 is a cross-sectional view corresponding to FIG. 3, showing an attachment portion according to a modification.

FIG. 6 is a cross-sectional view corresponding to FIG. 3, showing an attachment portion according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A vehicle emblem according to an embodiment will now be described with reference to FIGS. 1 to 3. In the present embodiment, the present disclosure is embodied as a luminous emblem 14 that is attached to a vehicle 10.

In the following description, the front-rear direction of the vehicle 10 will hereafter be referred to as a front-rear direction X, and the front and the rear in the front-rear direction X will simply be referred to as front and rear.

### Luminous Emblem 14

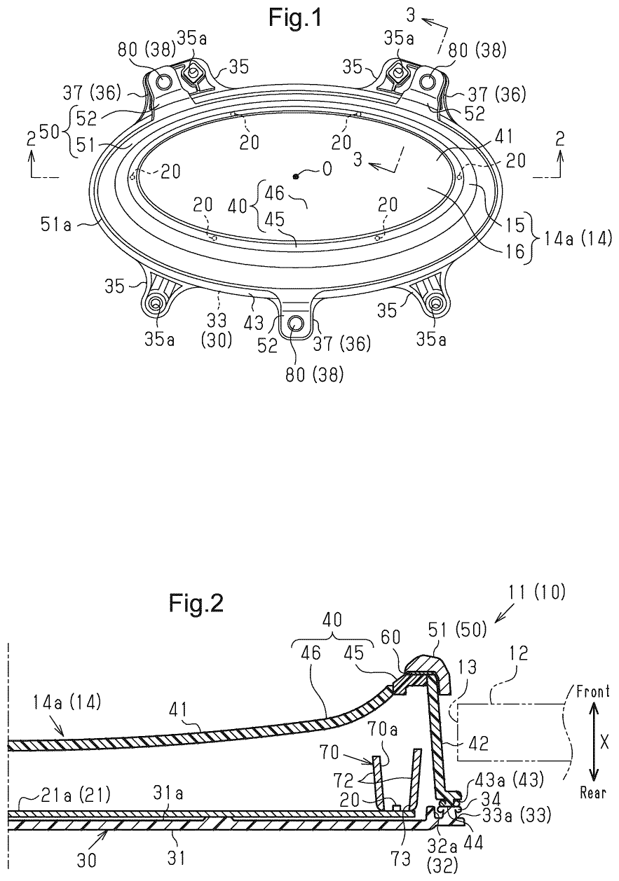

As shown in FIGS. 1 and 2, a front portion 11 of the vehicle 10 is provided with a front panel 12, which forms a part of the outer shell of the front portion 11.

The front panel 12 includes a window 13 that opens forward. The luminous emblem 14 is fitted in the window 13. In the present embodiment, the luminous emblem 14 is disposed to be orthogonal to the front-rear direction X (see FIG. 2).

As shown in FIG. 1, a decorative surface 14a of the luminous emblem 14 has the shape of a circle centered on a point O (hereinafter, referred to as a center O) in a front view. Hereinafter, a direction away from the center O in the radial direction of the decorative surface 14a will be referred to as an outward direction. A direction along the outer edge of the decorative surface 14a will be referred to as a circumferential direction. The luminous emblem 14 is symmetrical with respect to an imaginary plane that extends in the front-rear direction X and the up-down direction in FIG. 1. For this reason, in FIG. 2, only the right side in the left-right direction of FIG. 1 is illustrated, and the left side is omitted from the drawing.

The decorative surface 14a of the luminous emblem 14 includes an indication region 15, which represents a mark facing the front, and a background region 16, which is a portion other than the indication region 15. The term “mark” in this description refers to elements such as stylized text (logotype) that represents the vehicle manufacturer's name, the model name, or the grade name; a symbolic figure representing the vehicle manufacturer (symbol mark); or a logo mark that combines the text and the figure. In the present embodiment, the indication region 15 represents a simple oval shape.

The luminous emblem 14 includes a substrate 21, on which light sources 20 are mounted, a base portion 30, a cover portion 40, a decorative portion 50, an adhesive layer 60, and a reflection plate 70.

Each component will now be described.

### Light Sources 20

As shown in FIGS. 1 and 2, multiple (six in the present embodiment) light sources 20 are mounted on the substrate 21. The light sources 20 are fixed to a front surface 21a of the substrate 21 and emit visible light (hereinafter, simply referred to as light) forward. An example of the light source 20 is a light-emitting diode (LED).

### Base Portion 30

As shown in FIG. 2, the base portion 30 is formed of a plastic. Examples of the plastic forming the base portion 30 include acrylonitrile-butadiene-styrene copolymer (ABS) plastic, acrylonitrile-ethylene-styrene copolymer (AES) plastic, acrylonitrile-styrene-acrylate copolymer (ASA) plastic, and polymer alloy of polycarbonate (PC) and ABS plastic. In the present embodiment, the base portion 30 is formed of AES plastic.

The base portion 30 includes a flat portion 31, a frame portion 32 surrounding the flat portion 31, and a base flange 33 protruding from the frame portion 32.

The substrate 21 is fixed to a front surface 31a of the flat portion 31.

The frame portion 32 is bent and extends forward from the outer peripheral edge of the flat portion 31. The frame portion 32 is provided over the entire circumference of the flat portion 31.

The base flange 33 protrudes outward from an outer circumferential surface 32a of the frame portion 32. The base flange 33 includes a welding rib 34 projecting forward from a front surface 33a. The welding rib 34 is provided over the entire circumference of the base flange 33.

### Fixing Portions 35 and Attachment Portions 36

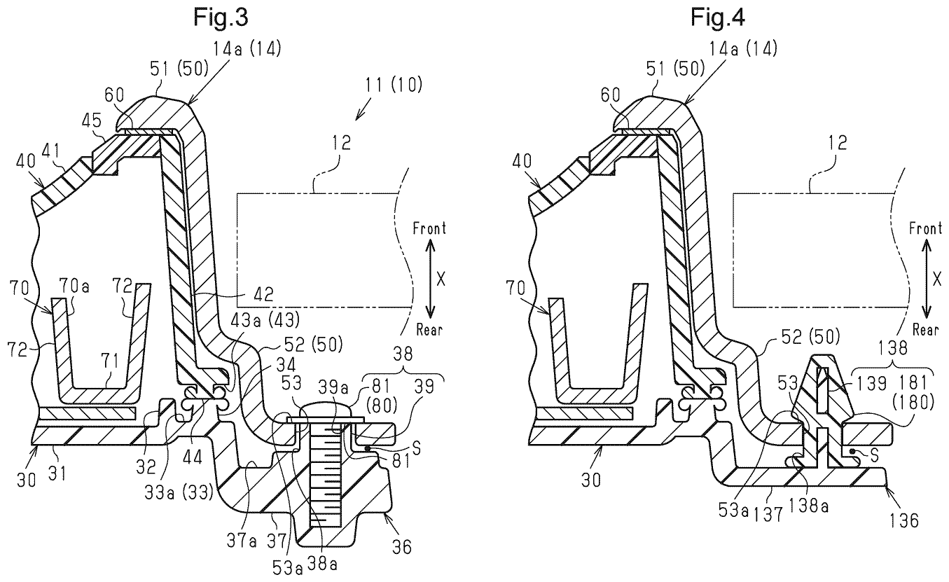

As shown in FIGS. 1 and 3, the base portion 30 includes fixing portions 35 and attachment portions 36, which extend further outward beyond the base flange 33. The fixing portions 35 and the attachment portions 36 are disposed rearward of the front panel 12 (see FIG. 3).

As shown in FIG. 1, the fixing portions 35 are used to attach the base portion 30 to the vehicle 10. In the present embodiment, four fixing portions 35 are arranged at intervals in the circumferential direction. Each fixing portion 35 includes a hole 35a, through which a screw (not shown) is inserted. A screw (not shown) is inserted into each hole 35a and screwed into a fastening hole (not shown) formed in a mounting surface (not shown) of the vehicle 10, so that the base portion 30 is fixed to the mounting surface.

As shown in FIGS. 1 and 3, the attachment portions 36 are used to attach the decorative portion 50 to the base portion 30. In the present embodiment, three attachment portions 36 are arranged at intervals in the circumferential direction. Two of the three attachment portions 36 that are located on the upper side in FIG. 1 are each formed integrally with a fixing portion 35.

Each attachment portion 36 includes a facing portion 37, which faces the decorative portion 50 in the front-rear direction X, and a protruding portion 38, which protrudes from the facing portion 37.

As shown in FIG. 3, the facing portion 37 is connected to the base flange 33.

The protruding portion 38 includes a boss 39, which protrudes forward from a front surface 37a of the facing portion 37, and a screw 80 threaded into a fastening hole 39a of the boss 39. A head 81 of the screw 80 is in contact with the distal end of the boss 39.

### Cover Portion 40

As shown in FIGS. 1 and 2, the cover portion 40 is formed of a plastic and covers the base portion 30 from the outside of the vehicle 10 (from the front in the present embodiment). In the present embodiment, the direction in which the base portion 30 and the cover portion 40 face each other agrees with the front-rear direction X.

As shown in FIG. 2, the cover portion 40 includes a main wall 41, which covers the entire flat portion 31 from the front, a circumferential wall 42, which is bent and extends rearward from the outer peripheral edge of the main wall 41, and a cover flange 43.

The main wall 41 includes a light transmitting portion 45, which transmits the light emitted from the light sources 20. The light transmitting portion 45 is formed of a transparent plastic that is transmissive to visible light. Examples of the transparent plastic include acrylic plastic such as polymethyl methacrylate plastic (PMMA) and PC.

In the present embodiment, the light transmitting portion 45 has an annular shape extending in the circumferential direction (see FIG. 1).

As shown in FIG. 2, the cover flange 43 is bent and extends outward from the rear end of the circumferential wall 42. The cover flange 43 includes a welding rib 44 projecting rearward from a rear surface 43a. The welding rib 44 is provided over the entire circumference of the cover flange 43. The cover portion 40 is fixed to the base portion 30 by welding the welding rib 44 to the welding rib 34. The welding process includes, for example, ultrasonic welding, laser beam welding, or hot plate welding.

A part of the cover portion 40 other than the light transmitting portion 45 is a light blocking portion 46, which blocks light emitted from the light sources 20. The light blocking portion 46 of the main wall 41 corresponds to the background region 16. In the present embodiment, the light blocking portion 46 is formed of ASA plastic.

### Decorative Portion 50

The decorative portion 50 decorates the cover portion 40, and includes a base (not shown) made of a plastic and a plating layer (not shown) formed by plating the surface of the base.

Examples of the plastic forming the base include ABS plastic, polypropylene (PP), polyphenylene oxide (PPO), polyamide (PA), polysulfone (PSF), and polyester (PEs). In the present embodiment, the base is formed of ABS plastic.

As shown in FIGS. 1 to 3, the decorative portion 50 includes a decorative main body 51 and extensions 52.

As shown in FIGS. 2 and 3, the decorative main body 51 is bonded to the cover portion 40 via an adhesive layer 60. In the present embodiment, the adhesive layer 60 is an adhesive such as double-sided tape, and is sandwiched between the decorative main body 51 and the cover portion 40 in the front-rear direction X.

The decorative main body 51 partially overlaps with the light transmitting portion 45 in the front-rear direction X. Specifically, the decorative main body 51 covers the outer peripheral part of the light transmitting portion 45 from the front. The inner peripheral part of the light transmitting portion 45 is exposed toward the front. In the present embodiment, the decorative main body 51 and the part of the light transmitting portion 45 that is exposed toward the front correspond to the indication region 15, which is visually recognized from the front.

As shown in FIG. 1, the extensions 52 extend outward from an outer peripheral edge 51a of the decorative main body 51 beyond the cover portion 40. In the present embodiment, the extensions 52 are provided at positions facing the facing portions 37 of the three attachment portions 36 in the front-rear direction X.

As shown in FIG. 3, each extension 52 includes a through-hole 53, which extends through the extension 52 in the front-rear direction X. The boss 39 of the corresponding protruding portion 38 is inserted into the through-hole 53.

A peripheral edge 53a of the through-hole 53 is in contact with the head 81 of the corresponding screw 80. The peripheral edge 53a is in contact with the head 81 over the entire circumference. The head 81 of the screw 80 is positioned on the distal (front) side of the through-hole 53 in the front-rear direction X in the protruding portion 38. In the present embodiment, the head 81 of the screw 80 corresponds to a retaining portion according to the present disclosure.

A gap S is formed between the extension 52 and the facing portion 37. The gap S is configured to allow the extension 52 to move along the boss 39 between a proximal end 38a in the front-rear direction X of the protruding portion 38 (in the present embodiment, the proximal end of the boss 39) and the head 81 of the screw 80.

### Reflection Plate 70

As shown in FIGS. 2 and 3, a reflection plate 70, which reflects light emitted from the light sources 20, is disposed between the base portion 30 and the cover portion 40.

The reflection plate 70 is formed from a composite material that includes a plastic mixed with a white pigment. Examples of the plastic include ABS plastic, AES plastic, ASA plastic, acrylic plastic such as PMMA, and PC.

The reflection plate 70 is fixed to the front surface 21a of the substrate 21 at a position overlapping with the light transmitting portion 45 in the front-rear direction X.

The reflection plate 70 includes a bottom wall 71 (see FIG. 3) and two side walls 72, which are bent from the opposite ends in the width direction of the bottom wall 71 and extend forward.

As shown in FIG. 2, the bottom wall 71 of the reflection plate 70 includes multiple holes 73, through which the light sources 20 are exposed toward the front.

The reflection plate 70 is configured to guide light toward the light transmitting portion 45 by reflecting the light, emitted from the light sources 20 and incident on the inner surface 70a, once or multiple times on the inner surface 70a.

### Operation of the Present Embodiment

Operation of the present embodiment will now be described.

As shown in FIG. 3, when the decorative main body 51 is bonded to the cover portion 40 via the adhesive layer 60, first, the bosses 39 are inserted into the through-holes 53 of the extensions 52. This positions the decorative portion 50 relative to both the base portion 30 and the cover portion 40.

In a state in which the decorative portion 50 is positioned in this manner, the decorative portion 50 is pushed toward the cover portion 40 in the front-rear direction X. The gap S is created between each extension 52 and the facing portion 37 of the corresponding attachment portion 36. Accordingly, the decorative portion 50 can be pushed toward the cover portion 40 by an amount corresponding to the gap S. Thus, the decorative main body 51 is pressed against the cover portion 40.

Thereafter, the decorative portion 50 is attached to the base portion 30 via the extensions 52 by threading the screws 80 into the fastening holes 39a of the bosses 39 inserted into the through-holes 53.

The decorative portion 50 is pushed (forward) away from the cover portion 40 by the elasticity of the adhesive layer 60. Accordingly, the extensions 52 move forward along the bosses 39. Therefore, the gap S is formed again between each extension 52 and the corresponding facing portion 37.

### Advantages of the Present Embodiment

The present embodiment has the following advantages.

(1) The decorative portion 50 includes the decorative main body 51, which is bonded to the cover portion 40 via the adhesive layer 60 and the extensions 52, which extend outward from the decorative main body 51 beyond the cover portion 40. Each extension 52 includes the through-hole 53, which extends through the extension 52 in the front-rear direction X. The base portion 30 includes the attachment portions 36, to which the extensions 52 are attached. Each attachment portion 36 includes the facing portion 37, which faces the corresponding extension 52 in the front-rear direction X, and the protruding portion 38, which protrudes from the facing portion 37 in the front-rear direction X and includes the boss 39. The boss 39 is inserted into the through-hole 53. Each protruding portion 38 includes the head 81 of the screw 80 on the distal (front) side of the through-hole 53 in the front-rear direction X. The head 81 acts as the retaining portion that comes into contact with the peripheral edge 53a of the through-hole 53 to retain the protruding portion 38 in the through-hole 53.

This configuration bonds the decorative main body 51 to the cover portion 40 via the adhesive layer 60. Therefore, even when deformation such as warpage due to molding shrinkage occurs in the base of the decorative portion 50, the adhesive layer 60 prevents the occurrence of separation of the decorative main body 51. This prevents the aesthetic quality of the luminous emblem 14 from being degraded due to such separation.

According to the above-described configuration, the extensions 52 of the decorative portion 50 are attached to the attachment portions 36 provided on the base portion 30 by inserting the protruding portions 38 into the through-holes 53. Each protruding portion 38 includes the head 81 of the screw 80 as a retaining portion, and the head 81 comes into contact with the peripheral edge 53a of the corresponding through-hole 53, so as to retain the protruding portion 38 in the through-hole 53. Therefore, even when the adhesive force of the adhesive layer 60 is weakened due to deterioration over time, the extensions 52 remain attached to the attachment portions 36, preventing the decorative portion 50 from detaching.

Therefore, it is possible to prevent the decorative portion 50 from detaching while limiting a decrease in the aesthetic quality of the luminous emblem 14.

With the above-described configuration, the attachment portions 36, to which the extensions 52 are attached, are provided on the base portion 30. Therefore, it is not necessary to separately provide attachment portions for attaching the decorative portion 50 to the mounting surface of the vehicle 10, which is the mounting object for the luminous emblem 14. This arrangement helps prevent the mounting object from becoming more complex.

(2) The adhesive layer 60 is sandwiched between the decorative main body 51 and the cover portion 40 in the front-rear direction X. The gap S exists between each extension 52 and the corresponding facing portion 37. The gap S allows the extension 52 to move along the boss 39 of the protruding portion 38 between the proximal end 38a in the front-rear direction X of the protruding portion 38 and the head 81 of the screw 80.

When the decorative main body 51 is bonded to the cover portion 40 via the adhesive layer 60, the decorative portion 50 is pushed toward the cover portion 40 in the front-rear direction X, so that the decorative main body 51 is pressed against the cover portion 40. This allows the decorative main body 51 to be firmly bonded to the cover portion 40.

For example, if the extensions 52 and the facing portions 37 were attached to each other without gaps, the facing portions 37 would restrict the decorative portion 50 from being pushed toward the cover portion 40. Therefore, the decorative main body 51 would not be sufficiently bonded to the cover portion 40. In this regard, with the above-described configuration, the gap S exists between each extension 52 and the corresponding facing portion 37. The gap S allows the extension 52 to move along the boss 39 between the proximal end 38a in the front-rear direction X of the protruding portion 38 and the head 81 of the screw 80. Accordingly, the decorative portion 50 can be pushed toward the cover portion 40 by an amount corresponding to the gap S. This allows the decorative main body 51 to be pressed against the cover portion 40.

Therefore, the decorative portion 50 is more firmly bonded to the cover portion 40.

### MODIFICATIONS

The above-described embodiment may be modified as follows. The above-described embodiment and the following modifications can be combined as long as the combined modifications remain technically consistent with each other.

The decorative portion 50 is not limited to the one formed by plating the surface of a base made of a plastic as described in the above-described embodiment. For example, the decorative portion 50 may be formed by applying a paint in which a pigment or a metal filler is dispersed to the surface of the base. Further, the decorative portion 50 may be formed of only a base in which a pigment is dispersed.

The light blocking portion 46 may be formed of, for example, a mixed material obtained by mixing a plastic such as PC and a black pigment such as carbon black. In addition, the light blocking portion 46 may be formed by performing a coating or plating process having a light blocking property on a portion of the cover portion 40 other than the light transmitting portion 45.

The numbers of fixing portions 35 and attachment portions 36 are not limited to the numbers described in the above-described embodiment, and may be changed as long as the numbers are at least one.

The attachment portion according to the present disclosure is not limited to the attachment portion having the protruding portion 38 including the boss 39 and the screw 80 as described in the above-described embodiment. For example, FIG. 4 shows an alternative attachment portion 136, which includes a protruding portion 138. The protruding portion 138 includes a clip attachment portion 139 protruding from a facing portion 137 and a clip member 180 attached to the clip attachment portion 139. In this case, a distal end portion 181 of the clip member 180 corresponds to the retaining portion according to the present disclosure. It suffices to form a gap S between the extension 52 and the facing portion 137 to allow the extension 52 to move along the clip member 180 between a proximal end 138a of the protruding portion 138 in the front-rear direction X (in the present modification, the proximal end of the clip member 180) and the distal end portion 181 of the clip member 180.

In this configuration, it is not necessary to provide the boss 39 in the facing portion 137. Therefore, the size of the facing portion 137 can be made smaller than that of the facing portion 37.

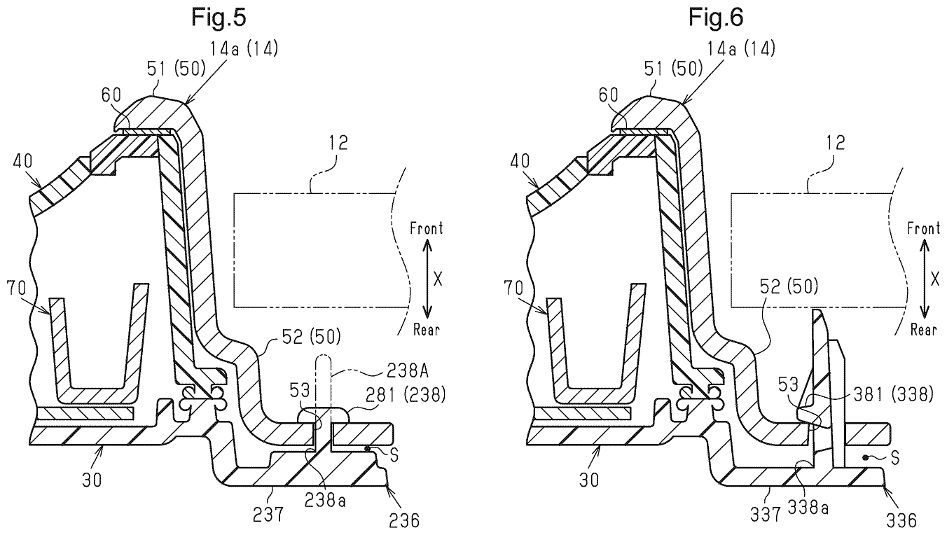

The attachment portion according to the present disclosure is not limited to an attachment portion in which the retaining portion is provided separately from the base portion as in the attachment portions 36, 136. For example, as shown in FIG. 5, the attachment portion may be an attachment portion 236 that includes a protruding portion 238 in which a retaining portion 281 is formed by upsetting the distal end of a protruding portion 238A indicated by the long-dash double-short-dash line. In this case, it suffices to form the space S between the extension 52 and the facing portion 237 to allow the extension 52 to move along the protruding portion 238 between the proximal end 238a in the front-rear direction X of the protruding portion 238 and the retaining portion 281.

With this configuration, first, the decorative portion 50 is pressed against the cover portion 40 in a state in which the protruding portion 238A is inserted into the through-hole 53 of the extension 52. Thereafter, the decorative portion 50 is attached to the base portion 30 via the extension 52 by upsetting the distal end of the protruding portion 238A. Therefore, the number of components can be reduced as compared with the case in which the retaining portion is formed by the screw 80 or the clip member 180.

As shown in FIG. 6, the above-described attachment portion 236 may be replaced with an attachment portion 336 that includes a protruding portion 338 including a hook portion 381 as a retaining portion. In this case, it suffices to form a gap S between the extension 52 and the facing portion 337 to allow the extension 52 to move along the protruding portion 338 between the proximal end 338a in the front-rear direction X of the protruding portion 338 and the hook portion 381.

The attachment portion according to the present disclosure is not limited to the one provided on the base portion 30 as illustrated in the above-described embodiment. For example, the attachment portion may be provided on the cover portion 40. In this case, it suffices to couple the facing portion of the attachment portion to the outer periphery of the cover flange 43.

The shape of the mark represented by the indication region 15 of the luminous emblem 14 is not limited to the oval shape described in the above-described embodiment, and the shape may be changed in accordance with the specification of the vehicle 10.

The vehicle emblem according to the present disclosure is not limited to the luminous emblem 14 described in the above-described embodiment, and the light sources 20 and the substrate 21 may be omitted.

With this configuration, the reflection plate 70 can be omitted. Therefore, the size of the vehicle emblem can be reduced. In addition, with this configuration, the light transmitting portion 45 and the light blocking portion 46 can be omitted from the cover portion 40. In this case, the entire cover portion 40 can be integrally formed of the same plastic, for example, ASA plastic. This facilitates the molding of the cover portion 40.

The vehicle emblem according to the present disclosure is not limited to an emblem attached to the front panel 12, which forms a part of the outer shell in the front portion 11 of the vehicle 10. For example, the vehicle emblem may be attached to a vehicle exterior component such as a back door decorative component forming the outer shell at the rear portion of the vehicle 10, a side door decorative component forming the outer shell at a side portion of the vehicle 10, or a pillar decorative component.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle emblem, comprising:
a base portion;
a cover portion that covers the base portion from an outside of the vehicle;
a decorative portion that includes a base made of a plastic and decorates the cover portion; and
an adhesive layer for bonding the decorative portion to the cover portion, wherein
the decorative portion includes:
a decorative main body bonded to the cover portion via the adhesive layer; and
an extension extending outward from the decorative main body beyond the cover portion,
a direction in which the base portion and the cover portion face each other is referred to as a facing direction,
the extension includes a through-hole extending through the extension in the facing direction,
one of the base portion and the cover portion includes an attachment portion to which the extension is attached,
the attachment portion includes:
a facing portion facing the extension in the facing direction; and
a protruding portion that protrudes in the facing direction from the facing portion and is inserted into the through-hole, and
the protruding portion includes a retaining portion that is located on a distal side of the through-hole in the facing direction, the retaining portion coming into contact with a peripheral edge of the through-hole to retain the protruding portion in the through-hole.

2. The vehicle emblem according to claim 1, wherein
the adhesive layer is sandwiched between the decorative main body and the cover portion in the facing direction,
a gap is formed between the extension and the facing portion, and
the gap allows the extension to move along the protruding portion between a proximal end in the facing direction of the protruding portion and the retaining portion.
